(19) United States
(12) Patent Application Publication
(10) Pub. No.: US 2026/0369995 A1
(43) Pub. Date: Nov. 19, 2026

(54) POWER SUPPLY SYSTEM

(71) Applicant: VERTIV CORPORATION, Westerville, OH (US)

(72) Inventors: Xin XIANG, Shenzhen (CN); Donglan WU, Shenzhen (CN); Min LI, Shenzhen (CN); Cong NING, Shenzhen (CN); Biao WU, Shenzhen (CN); Junjie CHEN, Shenzhen (CN)

(73) Assignee: VERTIV CORPORATION, Westerville, OH (US)

(21) Appl. No.: 19/444,031

(22) Filed: Jan. 8, 2026

(30) Foreign Application Priority Data
May 14, 2025 (CN) 202510619097.2

(51) Int. Cl. H02J 1/12; H02B 1/16; H02B 1/20; H02B 1/30; H02B 1/32; H02J 105/42

(52) U.S. Cl. CPC H02J 1/12; H02B 1/16; H02B 1/20; H02B 1/305; H02B 1/32; H02J 2105/425

(57) ABSTRACT

A power supply system is provided according to the present disclosure, and includes a cabinet, a power distribution unit, a rectifying unit, and a battery unit. The power distribution unit includes an AC power distribution unit and a DC power distribution unit. The cabinet further includes a copper bus-bar assembly and the cabinet is further provided with a grounding unit. The AC power distribution unit of the power distribution unit outputs AC power to the rectifying unit, the rectifying unit converts the AC power into DC power, then the copper bus-bar assembly converges the DC power to the DC power distribution unit, and the DC power distribution unit transmits the DC power to IT equipment of an AI data center.

### CROSS-REFERENCE TO RELATED APPLICATION

This application claims priority to Chinese Patent Application No. 202510619097.2 filed on May 14, 2025 and entitled “POWER SUPPLY SYSTEM”, the disclosure of which is incorporated herein by reference in its entirety.

### FIELD

The present disclosure relates to the technical field of power supply equipment, and in particular to a power supply system.

### BACKGROUND

Based on the current popularity of artificial intelligence (AI) and the explosive growth of data storage, the power level required by AI has reached the megawatt level. Conventional power supply systems have low power supply efficiency and have difficulty in meeting a power supply demand of high power-density equipment within a limited space

### SUMMARY

The objective of the present disclosure is to provide a power supply system to resolve the disadvantages of a conventional power supply system, such as low power supply efficiency and difficulty in meeting a power supply demand of high power-density equipment within a limited space.

The technical solution adopted in the present disclosure to solve the technical problem is to provide a power supply system which includes a cabinet, a power distribution unit disposed at a top of the cabinet, and a rectifying unit and a battery unit located below the power distribution unit and arranged sequentially from top to bottom, where the power distribution unit includes an alternating-current (AC) power distribution unit and a direct-current (DC) power distribution unit, the cabinet further includes a copper bus-bar assembly, which is configured to electrically connect the rectifying unit and the battery unit to the power distribution unit, and the cabinet is further provided with a grounding unit. The AC power distribution unit of the power distribution unit outputs AC power to the rectifying unit, the rectifying unit converts the AC power into DC power, then the copper bus-bar assembly converges the DC power to the DC power distribution unit, and the DC power distribution unit transmits the DC power to IT equipment of an AI data center. When the AC power distribution unit is powered off, the battery unit outputs DC power to the copper bus-bar assembly, then the copper bus-bar assembly transmits the DC power to the DC power distribution unit, and the DC power distribution unit transmits the DC power to the IT equipment of the AI data center. In this way, a method for supplying power to the IT equipment of the AI data center by using AC power input and DC power input of the power supply system can be achieved, thereby effectively improving the power supply efficiency of the power supply system. In addition, by disposing the power distribution unit at the top of the cabinet and arranging the rectifying unit and the battery unit below the power distribution unit from top to bottom, the utilization rate of internal space of the cabinet can be effectively improved, thereby further improving the power supply efficiency of the power supply system and meeting the power supply demand of high power-density equipment within a limited space.

Further, the AC power distribution unit includes an AC input cable for AC power input, an AC input connector electrically connected to the AC input cable, an AC power distribution module, an AC output cable electrically connected to the rectifying unit, and an AC output connector electrically connected to the AC output cable. An external plug-in frame of the AC power distribution unit is locked and fixed to the cabinet by a locking fastener, and is externally connected to AC power via the AC input cable. The AC power flows into the AC power distribution module through the AC input connector, then flows out of the AC power distribution module through the AC output connector and converges into the rectifying unit via the AC output cable. The AC power distribution unit includes 8 sets of AC power distribution modules arranged side by side, and each set of AC power distribution modules may equally divide three channels of AC input into four channels of AC power output, thus achieving 32 channels of AC output, thereby effectively improving the power supply efficiency of the power supply system. An overall height of the AC power distribution unit is 8OU. Thereby, within a limited space, the number of AC output lines is increased, effectively improving the AC power output efficiency of the AC power supply unit.

Furthermore, the AC power distribution unit further includes an AC input brush for the AC input cable to go through and in. The AC input cable passes through the AC input brush and is then electrically connected to the AC input connector, thereby effectively utilizing the AC input brush for dust prevention, effectively preventing dust and the like from entering the AC power distribution unit, thus ensuring the cleanliness inside the cabinet and the safety of the AC power distribution unit.

Further, the rectifying unit includes multiple rectifying modules which are electrically connected to the AC output cable, and are electrically connected to the DC power distribution unit through the copper bus-bar assembly. The AC power outputted by the AC power distribution unit flows into the rectifying modules of the rectifying unit via the AC output cable, and the rectifying modules convert three-phase AC power distributed by the AC power distribution unit into 400V high-voltage DC power, which then converges into the DC power distribution unit via the copper bus-bar assembly, and subsequently the DC power distribution unit transmits the DC power to the IT equipment of the AI data center. The rectifying unit includes five rectifying modules arranged from top to bottom, with a total height of 10OU, thereby effectively compressing the space required by the rectifying unit, and further improving the space utilization inside the cabinet while meeting a rectification requirement of the AC power distribution unit.

Further, the copper bus-bar assembly includes a vertical long copper bus-bar located at the rectifying unit and the battery unit, a vertical short copper bus-bar located at the DC power distribution unit, and a connection copper bus-bar disposed between the vertical long copper bus-bar and the vertical short copper bus-bar. The DC power outputted by the rectifying unit and the battery unit flows into the connection copper bus-bar via the vertical long copper bus-bar, converges into the vertical short copper bus-bar located at the DC power distribution unit via the connection copper bus-bar, and then converges into the DC power distribution unit via the vertical short copper bus-bar, and subsequently the DC power distribution unit transmits the DC power to the IT equipment of the AI data center. A bottom of the vertical long copper bus-bar is fixedly connected to a bottom shell of the cabinet by a locking fastener, and a middle and a top of the vertical long copper bus-bar are fixedly connected to a beam of the cabinet by a locking fastener, thereby effectively ensuring the stability of the vertical long copper bus-bar being fixed inside the cabinet. The vertical short copper bus-bar is fixed to the beam of the cabinet by a locking fastener, thereby effectively ensuring the stability of the vertical short copper bus-bar being fixed inside the cabinet.

Further, the DC power distribution unit includes a DC input connector electrically connected to the vertical short copper bus-bar, a DC power distribution module, a DC output connector electrically connected to the vertical long copper bus-bar, and a DC output cable configured to electrically connect equipment within the cabinet to the DC output connector. The DC power outputted by the rectifying unit and the battery unit converges into the vertical long copper bus-bar via the DC output connector, and converges into the vertical short copper bus-bar located at the DC power distribution unit via the connection copper bus-bar, then flows into the DC power distribution module via the DC input connector, and the DC power is transmitted to the IT equipment of the AI data center via the DC output cable. The DC power distribution unit includes 4 DC power distribution modules arranged sequentially from top to bottom, with a total height of 8OU, thereby further improving the space utilization inside the cabinet. The DC power distribution unit is installed inside the cabinet via a guide rail adapter, thereby effectively improving the convenience of the DC power distribution unit being installed inside the cabinet.

Further, the DC power distribution unit further includes a DC output brush for the DC output cable to go through and out. The DC output cable goes through and out of the DC output brush and then transmits the DC power to the IT equipment of the AI data center, thereby effectively utilizing the DC output brush for dust prevention, effectively preventing dust and the like from entering the DC power distribution unit, thus ensuring the cleanliness inside the cabinet and the safety of the DC power distribution unit.

Further, the battery unit includes multiple battery modules which are electrically connected to the DC power distribution unit through the copper bus-bar assembly. When the AC power distribution unit is powered off, the battery modules of the battery unit output DC power to the vertical long copper bus-bar via the DC output connector, the DC power converges into the vertical short copper bus-bar located at the DC power distribution unit via the connection copper bus-bar, then flows into the DC power distribution module via the DC input connector, and the DC power is transmitted to the IT equipment of the AI data center via the DC output cable. In this way, a method for supplying DC power input from the battery unit of the power supply system to the IT equipment of the AI data center can be achieved, thereby effectively improving the power supply efficiency of the power supply system.

Further, the grounding unit includes a grounding cable, a rubber cable passing block for the grounding cable to go through and in, and a grounding copper bus-bar electrically connected to the grounding cable. The grounding cable goes through the rubber cable passing block and is electrically connected to the grounding copper bus-bar, which can effectively ensure the overall safety of the power supply system.

Further, the cabinet is provided with a front door and a rear door, where the DC power distribution unit is located at the front door, and the AC power distribution unit is located at the rear door. Disposing the DC power distribution unit at the front door and disposing the AC power distribution unit at the rear door can ensure the safety of the power distribution unit inside the cabinet and effectively improve the convenience for operators to perform maintenance operations on the DC power distribution unit and the AC power distribution unit.

Beneficial effects of the power supply system according to the present disclosure are as follows. The AC power distribution unit of the power distribution unit outputs AC power to the rectifying unit, the rectifying unit converts the AC power into DC power, then the copper bus-bar assembly converges the DC power to the DC power distribution unit, and the DC power distribution unit transmits the DC power to IT equipment of an AI data center. When the AC power distribution unit is powered off, the battery unit outputs DC power to the copper bus-bar assembly, then the copper bus-bar assembly transmits the DC power to the DC power distribution unit, and the DC power distribution unit transmits the DC power to the IT equipment of the AI data center. In this way, a method for supplying power to the IT equipment of the AI data center by using AC power input and DC power input of the power supply system can be achieved, thereby effectively improving the power supply efficiency of the power supply system. In addition, by disposing the power distribution unit at the top of the cabinet and arranging the rectifying unit and the battery unit below the power distribution unit from top to bottom, the utilization rate of internal space of the cabinet can be effectively improved, thereby further improving the power supply efficiency of the power supply system and meeting the power supply demand of high power-density equipment within a limited space.

### BRIEF DESCRIPTION OF THE DRAWINGS

FIG. 1 is a first schematic structural diagram of a power supply system according to the present disclosure.

FIG. 2 is a second schematic structural diagram of the power supply system according to the present disclosure.

FIG. 3 is a schematic structural diagram of an AC power distribution unit in the power supply system according to the present disclosure.

FIG. 4 is a complementary enlarged view of the AC power distribution unit in the power supply system according to the present disclosure.

FIG. 5 is a schematic structural diagram of a copper bus-bar assembly in the power supply system according to the present disclosure.

FIG. 6 is a side cross-sectional view of the power supply system according to the present disclosure.

FIG. 7 is a schematic structural diagram of a DC power distribution unit in the power supply system according to the present disclosure.

FIG. 8 is a schematic structural diagram of a grounding unit in the power supply system according to the present disclosure.

Reference numerals in the drawings are listed below:
100—power supply system,
10—cabinet, 11—front door, 12—rear door, 13—beam, 20—AC power distribution unit,
21—AC input cable, 22—AC power distribution module, 23—AC input connector,
24—AC output cable, 25—AC output connector, 26—AC input brush,
30—rectifying unit, 40—DC power distribution unit, 41—DC input connector, 42—DC power distribution module,
43—DC output connector, 44—DC output cable, 45—DC output brush, 50—copper bus-bar assembly,
51—vertical long copper bus-bar, 52—connection copper bus-bar, 53—vertical short copper bus-bar, 60—battery unit,
70—grounding unit, 71—grounding cable, 72—rubber cable passing block, 73—grounding copper bus-bar.

### DETAILED DESCRIPTION

In order to illustrate the objectives, technical solutions and advantages of the present disclosure more clearly, the present disclosure will be further described in detail below in conjunction with the drawings and embodiments. It should be understood that the embodiments described herein are merely for explaining rather than limiting the present disclosure.

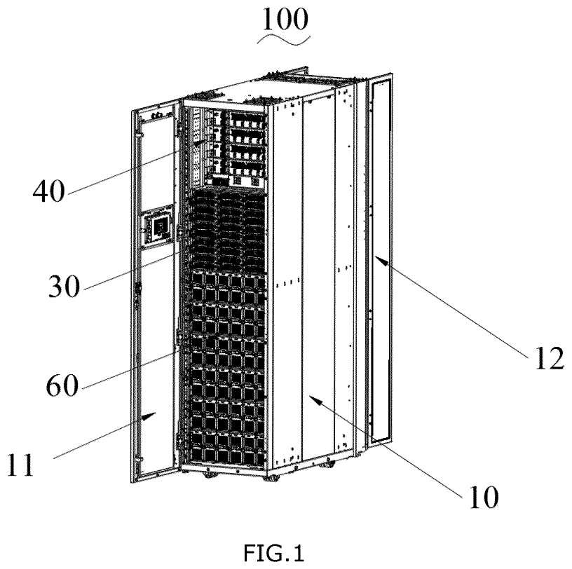

FIG. 1 to FIG. 8 show a power supply system 100 according to the present disclosure. The power supply system 100 includes a cabinet 10, a power distribution unit disposed at a top of the cabinet 10, and a rectifying unit 30 and a battery unit 60 located below the power distribution unit and arranged sequentially from top to bottom. The power distribution unit includes an AC power distribution unit 20 and a DC power distribution unit 40, the cabinet 10 further has a copper bus-bar assembly 50 which is configured to electrically connect the rectifying unit 30 and the battery unit 60 to the power distribution unit, and the cabinet 10 is further provided with a grounding unit 70. The power supply system 100 according to the present disclosure is a high-voltage direct current (HVDC) power supply system. In the power supply system 100, the AC power distribution unit 20 of the power distribution unit outputs AC power to the rectifying unit 30, the rectifying unit 30 converts the AC power into DC power, then the copper bus-bar assembly 50 converges the DC power to the DC power distribution unit, and the DC power distribution unit 40 transmits the DC power to IT equipment of an AI data center. When the AC power distribution unit 20 is powered off, the battery unit 60 outputs DC power to the copper bus-bar assembly 50, then the copper bus-bar assembly 50 transmits the DC power to the DC power distribution unit, and the DC power distribution unit 40 transmits the DC power to the IT equipment of the AI data center. In this way, a method for supplying power to the IT equipment of the AI data center by using AC power input and DC power input of the power supply system 100 can be achieved, thereby effectively improving the power supply efficiency of the power supply system 100. In addition, by disposing the power distribution unit at the top of the cabinet 10 and arranging the rectifying unit 30 and the battery unit 60 below the power distribution unit from top to bottom, the utilization rate of internal space of the cabinet 10 can be effectively improved, thereby further improving the power supply efficiency of the power supply system 100 and meeting the power supply demand of high power-density equipment within a limited space.

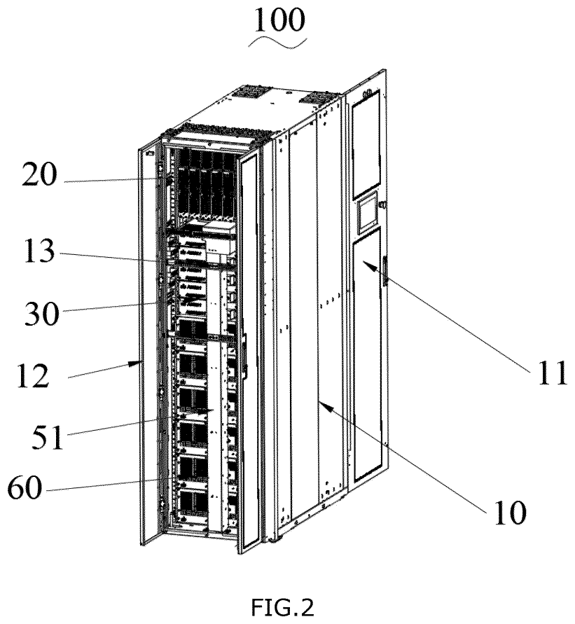

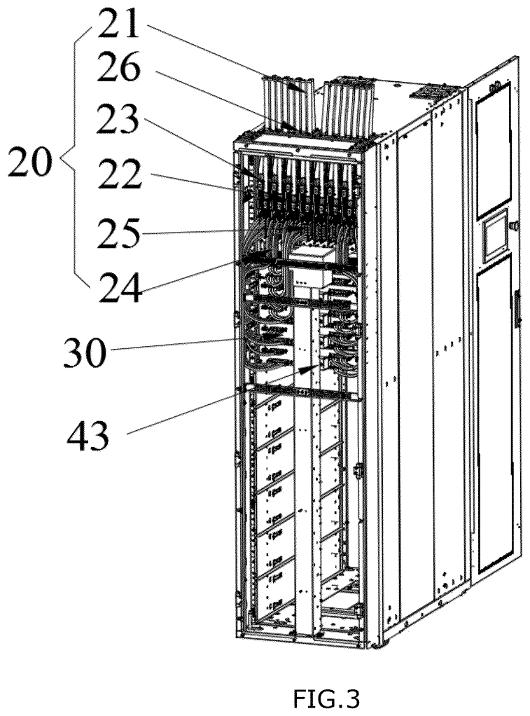

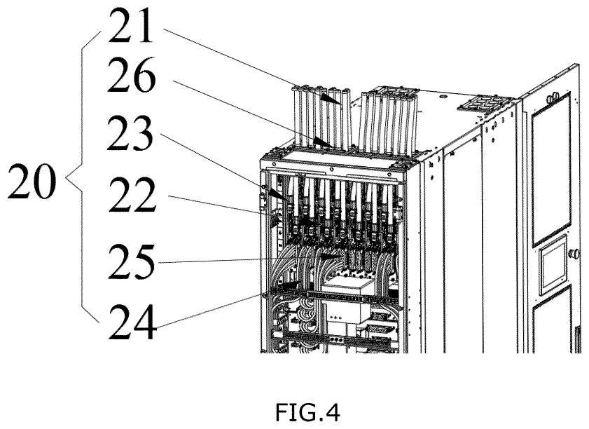

As shown in FIG. 2, FIG. 3, and FIG. 4, the AC power distribution unit 20 according to the present disclosure includes an AC input cable 21 for AC power input, an AC input connector 23 electrically connected to the AC input cable 21, an AC power distribution module 22, an AC output cable 24 electrically connected to the rectifying unit 30, and an AC output connector 25 electrically connected to the AC output cable 24. An external plug-in frame of the AC power distribution unit 20 is locked and fixed to the cabinet 10 by a locking fastener. The AC power is externally connected via the AC input cable 21, flows into the AC power distribution module 22 via the AC input connector 23, then flows out of the AC power distribution module 22 via the AC output connector 25, and converges into the rectifying unit 30 via the AC output cable 24. The AC power distribution unit 20 includes 8 sets of AC power distribution modules 22 arranged side by side, and each set of AC power distribution modules 22 may equally divide three channels of AC input into four channels of AC power output, thus achieving 32 channels of AC output, thereby effectively improving the power supply efficiency of the power supply system 100. The overall height of the AC power distribution unit 20 is 8OU. Thereby, within a limited space, the number of AC output lines is increased, effectively improving the AC power output efficiency of the AC power supply unit.

Furthermore, as shown in FIG. 3 and FIG. 4, the AC power distribution unit 20 further includes an AC input brush 26 for the AC input cable 21 to go through and in. The AC input cable 21 goes through the AC input brush 26 and is then electrically connected to the AC input connector 23, thereby effectively utilizing the AC input brush 26 for dust prevention, effectively preventing dust and the like from entering the AC power distribution unit 20, thus ensuring the cleanliness inside the cabinet 10 and the safety of the AC power distribution unit 20.

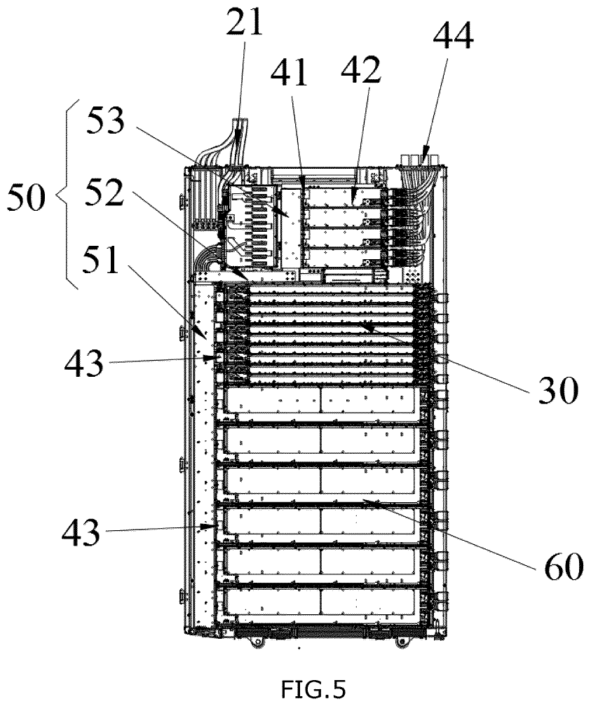

As shown in FIG. 1, FIG. 2, and FIG. 5, the rectifying unit 30 according to the present disclosure includes multiple rectifying modules which are electrically connected to the AC output cable 24, and are electrically connected to the DC power distribution unit 40 through the copper bus-bar assembly 50. The AC power outputted by the AC power distribution unit 20 flows into the rectifying modules of the rectifying unit 30 via the AC output cable 24, and the rectifying modules convert three-phase AC power distributed by the AC power distribution unit 20 into 400V high-voltage DC power, which then converges into the DC power distribution unit 40 via the copper bus-bar assembly 50, and subsequently the DC power distribution unit 40 transmits the DC power to the IT equipment of the AI data center. The rectifying unit 30 includes five rectifying modules arranged from top to bottom, with a total height of 10OU, thereby effectively reducing the space required by the rectifying unit 30, and further improving the space utilization inside the cabinet 10 while meeting a rectification requirement of the AC power distribution unit 20.

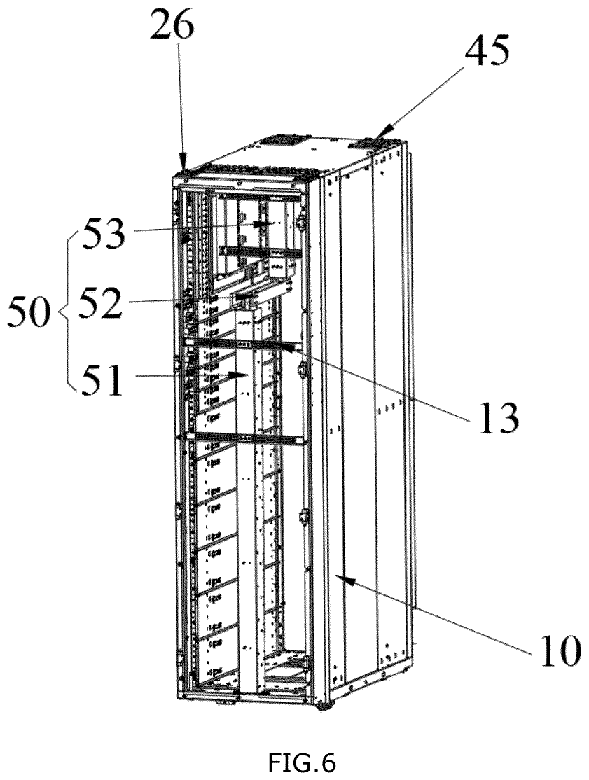

As shown in FIG. 1, FIG. 2, and FIG. 6, in the embodiment according to the present disclosure, the copper bus-bar assembly 50 includes a vertical long copper bus-bar 51 located at the rectifying unit 30 and the battery unit 60, a vertical short copper bus-bar 53 located at the DC power distribution unit 40, and a connection copper bus-bar 52 disposed between the vertical long copper bus-bar 51 and the vertical short copper bus-bar 53. The DC power outputted by the rectifying unit 30 and the battery unit 60 flows into the connection copper bus-bar 52 via the vertical long copper bus-bar 51, converges into the vertical short copper bus-bar 53 located at the DC power distribution unit 40 via the connection copper bus-bar 52, and converges into the DC power distribution unit 40 via the vertical short copper bus-bar 53, and subsequently the DC power distribution unit 40 transmits the DC power to the IT equipment of the AI data center. A bottom of the vertical long copper bus-bar 51 is fixedly connected to a bottom shell of the cabinet 10 by a locking fastener, and a middle and a top of the vertical long copper bus-bar 51 are fixedly connected to a beam 13 of the cabinet 10 by a locking fastener, thereby effectively ensuring the stability of the vertical long copper bus-bar 51 being fixed inside the cabinet 10. The vertical short copper bus-bar 53 is fixed to the beam 13 of the cabinet 10 by a locking fastener, thereby effectively ensuring the stability of the vertical short copper bus-bar being fixed inside the cabinet 10.

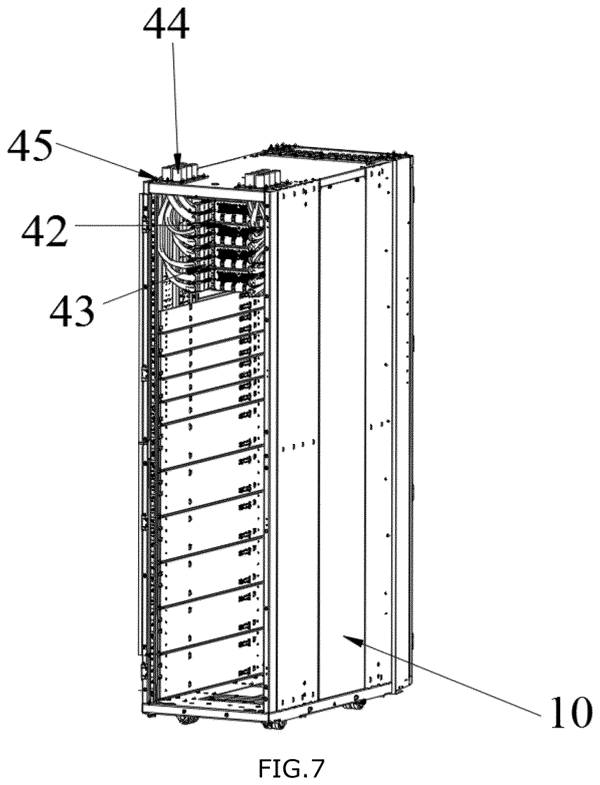

As shown in FIG. 1, FIG. 5, and FIG. 7, the DC power distribution unit 40 according to the present disclosure includes a DC input connector 41 electrically connected to the vertical short copper bus-bar 53, a DC power distribution module 42, a DC output connector 43 electrically connected to the vertical long copper bus-bar 51, and a DC output cable 44 configured to electrically connect equipment within the cabinet 10 to DC output connector 43. The DC power outputted by the rectifying unit 30 and the battery unit 60 converges into the vertical long copper bus-bar 51 via the DC output connector 43, converges into the vertical short copper bus-bar 53 located at the DC power distribution unit 40 via the connection copper bus-bar 52, and then flows into the DC power distribution module 42 via the DC input connector 41, and the DC power is transmitted to the IT equipment of the AI data center via the DC output cable 44. The DC power distribution unit 40 includes 4 DC power distribution modules 42 arranged sequentially from top to bottom, with a total height of 8OU, thereby further improving the space utilization inside the cabinet 10. The DC power distribution unit 40 is installed inside the cabinet 10 via a guide rail adapter, thereby effectively improving the convenience of the DC power distribution unit 40 being installed inside the cabinet 10.

Furthermore, as shown in FIG. 7, the DC power distribution unit 40 further includes a DC output brush 45 for the DC output cable 44 to go through and out. The DC output cable 44 goes through the DC output brush 45 and transmits the DC power to the IT equipment of the AI data center, thereby effectively utilizing the DC output brush 45 for dust prevention, effectively preventing dust and the like from entering the DC power distribution unit 40, thus ensuring the cleanliness inside the cabinet 10 and the safety of the DC power distribution unit 40.

As shown in FIG. 5, the battery unit 60 according to the present disclosure includes multiple battery modules which are electrically connected to the DC power distribution unit 40 through the copper bus-bar assembly 50. When the AC power distribution unit 20 is powered off, the battery modules of the battery unit 60 output DC power to the vertical long copper bus-bar 51 via the DC output connector 43, the DC power converges into the vertical short copper bus-bar 53 located at the DC power distribution unit 40 via the connection copper bus-bar 52, then flows into the DC power distribution module 42 via the DC input connector 41, and the DC power is transmitted to the IT equipment of the AI data center via the DC output cable 44. In this way, a method for supplying DC power input from the battery unit 60 of the power supply system 100 to the IT equipment of the AI data center can be achieved, thereby effectively improving the power supply efficiency of the power supply system 100.

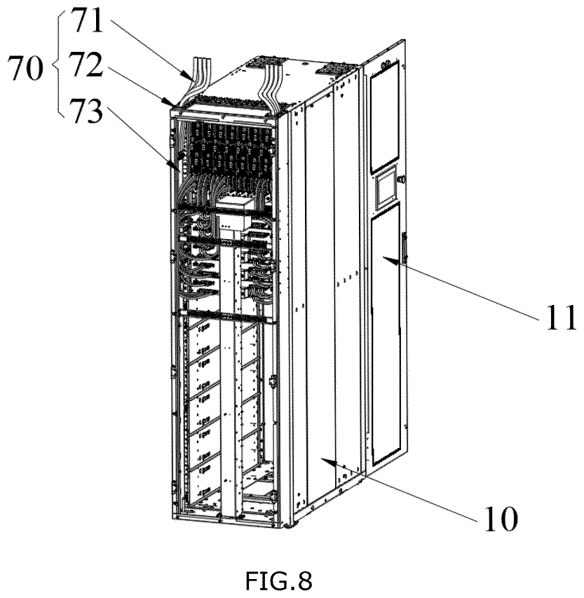

Furthermore, as shown in FIG. 8, the grounding unit 70 includes a grounding cable 71, a rubber cable passing block 72 for the grounding cable 71 to go through and in and a grounding copper bus-bar 73 electrically connected to the grounding cable 71. The grounding cable 71 goes through the rubber cable passing block 72 and is electrically connected to the grounding copper bus-bar 73, which can effectively ensure the overall safety of the power supply system 100.

As shown in FIG. 1 and FIG. 2, in the embodiment according to the present disclosure, the cabinet 10 is provided with a front door 11 and a rear door 12, where the DC power distribution unit 40 is located at the front door 11, and the AC power distribution unit 20 is located at the rear door 12. Disposing the DC power distribution unit 40 at the front door 11 and disposing the AC power distribution unit 20 at the rear door 12 can ensure the safety of the power distribution units inside the cabinet 10 and effectively improve the convenience for operators to perform maintenance operations on the DC power distribution unit 40 and the AC power distribution unit 20.

The embodiments above are only preferred embodiments of the present disclosure, and are not intended to limit the present disclosure. Any modifications, equivalent replacements and improvements made within the spirit and principle of the present disclosure shall be included within the protection scope of the present disclosure.

What is claimed is:

1. A power supply system, comprising: a cabinet (10), a power distribution unit disposed at a top of the cabinet (10), and a rectifying unit (30) and a battery unit (60) located below the power distribution unit and arranged sequentially from top to bottom; and
wherein the power distribution unit comprises an AC power distribution unit (20) and a DC power distribution unit (40), the cabinet (10) further comprises a copper bus-bar assembly (50), which is configured to electrically connect the rectifying unit (30) and the battery unit (60) to the power distribution unit, and the cabinet (10) is further provided with a grounding unit (70).

2. The power supply system according to claim 1, wherein the AC power distribution unit (20) comprises an AC input cable (21) for AC power input, an AC power distribution module (22), an AC input connector (23) electrically connected to the AC input cable (21), an AC output cable (24) electrically connected to the rectifying unit (30), and an AC output connector (25) electrically connected to the AC output cable (24).

3. The power supply system according to claim 2, wherein the AC power distribution unit (20) further comprises an AC input brush (26) for the AC input cable (21) to go through and in.

4. The power supply system according to claim 2, wherein the rectifying unit (30) comprises a plurality of rectifying modules which are electrically connected to the AC output cable (24), and are electrically connected to the DC power distribution unit (40) through the copper bus-bar assembly (50).

5. The power supply system according to claim 4, wherein the copper bus-bar assembly (50) comprises a vertical long copper bus-bar (51) located at the rectifying unit (30) and the battery unit (60), a vertical short copper bus-bar (53) located at the DC power distribution unit (40), and a connection copper bus-bar (52) disposed between the vertical long copper bus-bar (51) and the vertical short copper bus-bar (53).

6. The power supply system according to claim 5, wherein the DC power distribution unit (40) comprises a DC input connector (41) electrically connected to the vertical short copper bus-bar (53), a DC power distribution module (42), a DC output connector (43) electrically connected to the vertical long copper bus-bar (51), and a DC output cable (44) configured to electrically connect equipment within the cabinet (10) to the DC output connector (43).

7. The power supply system according to claim 6, wherein the DC power distribution unit (40) further comprises a DC output brush (45) for the DC output cable (44) to go through and out.

8. The power supply system according to claim 6, wherein the battery unit (60) comprises a plurality of battery modules which are electrically connected to the DC power distribution unit (40) through the copper bus-bar assembly (50).

9. The power supply system according to claim 1, wherein the grounding unit (70) comprises a grounding cable (71), a rubber cable passing block (72) for the grounding cable (71) to go through and in, and a grounding copper bus-bar (73) electrically connected to the grounding cable (71).

10. The power supply system according to claim 1, wherein the cabinet (10) is provided with a front door (11) and a rear door (12), wherein the DC power distribution unit (40) is located at the front door (11), and the AC power distribution unit (20) is located at the rear door (12).
